(19) United States
(12) Patent Application Publication
(10) Pub. No.: US 2025/0091058 A1
(43) Pub. Date: Mar. 20, 2025

(54) COLOR MANIFOLD AND VALVE ASSEMBLY

(71) Applicant: FANUC AMERICA CORPORATION, Rochester Hills, MI (US)

(72) Inventors: Chloe Truxton, Royal Oak, MI (US); Jeet Chitalia, Sterling Heights, MI (US)

(21) Appl. No.: 18/830,743

(22) Filed: Sep. 11, 2024

Related U.S. Application Data
(60) Provisional application No. 63/583,100, filed on Sep. 15, 2023.

(51) Int. Cl. B05B 1/16; B05B 12/14; B05B 13/04

(52) U.S. Cl. CPC B05B 1/169; B05B 12/1409; B05B 13/0431

(57) ABSTRACT

A paint manifold including a body having a fluid passage extending therethrough, a first valve having a valve tip positioned proximate the fluid passage, a second valve having a valve tip positioned proximate the fluid passage, and a third valve having a valve tip positioned proximate the fluid passage. The manifold also includes a paint supply passage extending through the body and being coupled to the first valve, a paint return passage extending through the body and being coupled to the first valve, a paint supply passage extending through the body and being coupled to the second valve, a paint return passage extending through the body and being coupled to the second valve, a paint supply passage extending through the body and being coupled to the third valve, and a paint return passage extending through the body and being coupled to the third valve.

### CROSS REFERENCE TO RELATED APPLICATIONS

This application claims the benefit of the filing date of U.S. provisional application No. 63/583,100, titled, Color Manifold and Valve Assembly, filed Sep. 15, 2023, the entirety of which is herein expressly incorporated by reference.

### BACKGROUND

### Field

This disclosure relates generally to a fluid manifold and, more particularly, to a paint manifold for a robotic paint delivery system that includes three valves positioned on a common plane and each having a valve tip positioned proximate a central paint passage.

### Discussion of the Related Art

Robots are known to perform a multitude of tasks including painting an object, such as a vehicle body. A typical robotic painting station for painting, for example, the exterior surfaces of vehicle bodies in both a continuous conveyance and stop station systems includes a spray booth, a plurality of painting robots and opener/closer robots disposed on a periphery thereof. These robots can be mounted on the floor, the wall, the ceiling or side rails. The painting robots carry either spray guns or rotary applicators for directing atomized paint toward the vehicle body.

A typical paint delivery system for a painting robot will include a paint manifold having a number of valves that are controlled to selectively provide paints of various colors to a fluid manifold that meters and controls the flow of paint to the paint applicator. Vehicle paint is expensive, and therefore efforts are made to limit paint waste. One way to do that is to reduce the amount of paint that is in the manifolds at the end of a painting job that is generally purged to a paint dump to clean the manifolds for the next painting job. The distance that the paint has to travel through hoses and passageways in these manifolds varies from design to design. One way to reduce the amount of paint that is in the manifolds at the end of a painting job is to reduce the distance that the paint has to go from the paint source to the applicator.

### SUMMARY

The following discussion discloses and describes a paint manifold including a body having a fluid passage extending therethrough, a first valve extending into the body and having a valve tip positioned proximate the fluid passage, a second valve extending into the body and having a valve tip positioned proximate the fluid passage, and a third valve extending into the body and having a valve tip positioned proximate the fluid passage. Each valve includes a valve rod seal having sealing surfaces that seal against the body and a valve seat having a hemispherical surface. The manifold also includes a fluid supply passage extending through the body and being coupled to the first valve, a fluid return passage extending through the body and being coupled to the first valve, a fluid supply passage extending through the body and being coupled to the second valve, a fluid return passage extending through the body and being coupled to the second valve, a fluid supply passage extending through the body and being coupled to the third valve, and a fluid return passage extending through the body and being coupled to the third valve.

Additional features of the present disclosure will become apparent from the following description and appended claims, taken in conjunction with the accompanying drawings.

### BRIEF DESCRIPTION OF THE DRAWINGS

FIG. 1 is an isometric view of a painting robot;

FIG. 2 is a schematic type diagram of a paint delivery system including a paint manifold and a paint canister that can be used with the painting robot shown in FIG. 1;

FIG. 3 is a schematic type diagram of another paint delivery system including a paint manifold and a pump manifold that can be used with the painting robot shown in FIG. 1;

FIG. 4 is a front isometric view of a paint manifold that can be used as the paint manifold in the paint delivery systems shown in FIGS. 2 and 3;

FIG. 5 is a back isometric view of the paint manifold shown in FIG. 4;

FIG. 6 is a front view of the paint manifold shown in FIG. 4;

FIG. 7 is a back view of the paint manifold shown in FIG. 4;

FIG. 8 is a side view of the paint manifold shown in FIG. 4;

FIG. 9 is a top view of the paint manifold shown in FIG. 4;

FIG. 10 is a back view of the paint manifold shown in FIG. 4 and having a transparent block to show fluid passages therein;

FIG. 11 is an isometric view of the paint manifold illustrating sockets for valves positioned therein; and

FIG. 12 is a broken away front view of the paint manifold illustrating a cross-sectional type view of one of the valves positioned therein.

### DETAILED DESCRIPTION OF THE EMBODIMENTS

The following discussion of the embodiments of the disclosure directed to a paint manifold for a robotic paint delivery system that includes three valves positioned on a common plane and each having a valve tip positioned proximate a central fluid passage is exemplary in nature, and is in no way intended to limit the invention or its applications or uses. For example, although the discussion herein is specific to a paint delivery system for a painting robot that paints a vehicle part, the paint delivery system may have application for dispensing other coatings or fluids by other devices for other applications.

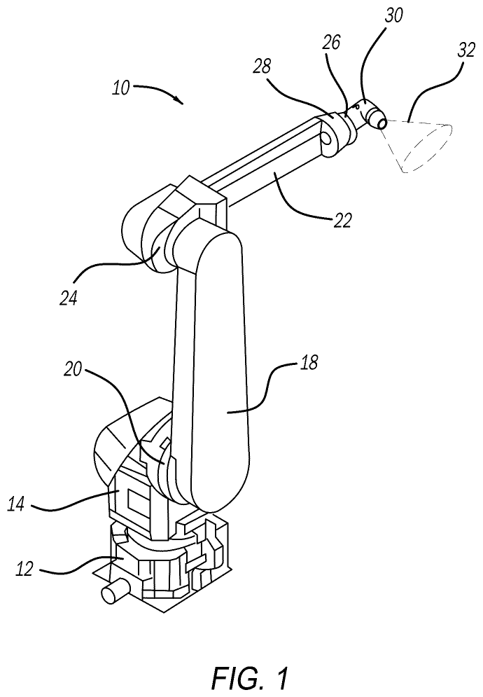

FIG. 1 is an isometric view of a painting robot 10 mounted to a fixed base mounting stand 12, where the robot 10 is intended to represent any painting robot suitable for the purposes discussed herein. A turret or robot base 14 is rotatably mounted to the mounting stand 12. An inner arm 18 is rotatably coupled to the base 14 by a joint 20, an outer arm 22 is rotatably coupled to the inner arm 18 by a joint 24, and a wrist member 26 is rotatably coupled to the outer arm 22 by a joint 28. An applicator 30 is fixedly attached to the wrist member 26 at an angle optimized for a painting application, where paint spray 32 is shown being emitted from the applicator 30.

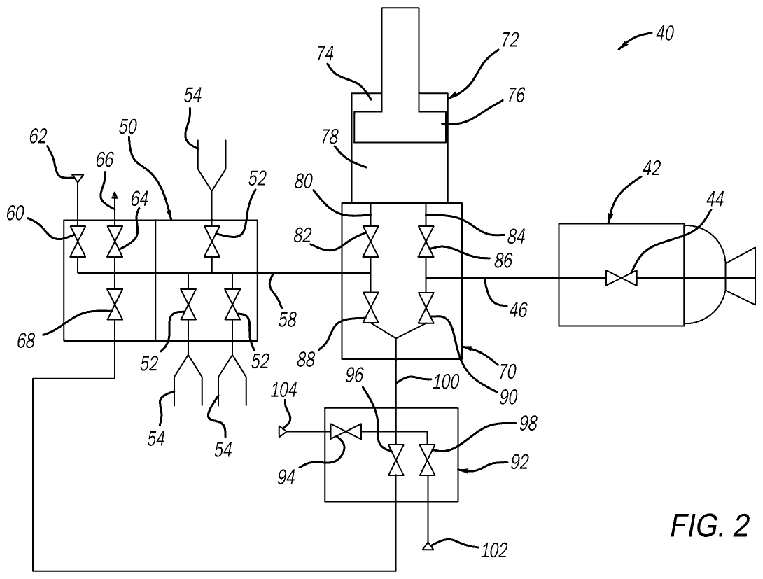

FIG. 2 is a schematic type block diagram of a paint delivery system 40 that can be used with the painting robot 10 shown in FIG. 1. It is noted that although the discussion herein is specific to a painting robot that paints, for example, a vehicle body, the paint delivery system 40 may have application for dispensing other coatings or fluids by other devices for other applications. The system 40 includes an applicator 42, for example, a rotary atomizer, having a trigger valve 44, connected to a paint dispensing line 46, where the various valves and manifolds in the system 40 may be mounted to the outer arm 22 and the applicator 42 would be part of an end-effector on the robot 10. The system 40 also includes a paint manifold 50 having a plurality of color valves 52 that are selectively opened to obtain paint from a plurality of paint sources 54 and provide the paint to an isolation line 58. The paint manifold 50 also includes a solvent valve 60 that is selectively opened to provide solvent on the isolation line 58 from a solvent source 62. The paint manifold 50 also includes a dump valve 64 for releasing solvent and air from the system 40 to a dump outlet 66. The paint manifold 50 further includes a vacuum valve 68 coupled to a vacuum source for evacuating air from the passages in the system 40 before they are filled with paint.

The system 40 further includes a canister manifold 70 having a paint canister 72 attached thereto, where the canister 72 includes a chamber 74. The canister 72 also includes a piston 76 defining a paint volume 78 in the chamber 74 therebetween, which holds a predetermine volume of paint when the canister 72 is loaded with paint, where the piston 76 can be pneumatically driven, fluid driven, etc. A paint input line 80 allows the volume 78 to be filled with paint from the isolation line 58 through a paint input valve 82 and a paint output line 84 allows paint to be dispensed from the paint volume 78 by movement of the piston 76 into the paint dispensing line 46 through a paint outlet valve 86. A pair of valves 88 and 90 in the manifold 70 allow the various lines in the manifold 70 to be cleaned with solvent and dried in a manner well understood by those skilled in the art.

The system 40 also includes a cleaning manifold 92 having valves 94, 96 and 98 that are coupled to the valves 88 and 90 in the manifold 70 by an isolation line 100. A solvent source 102 provides solvent to the manifold 92 through the valve 98. An air source 104 provides drying air to the manifold 92 through the valve 94. The paint canister 72 and the applicator 44 are at high voltage and the paint manifold 50 and the manifold 92 are grounded by a fluid supply during the painting operation. Therefore, the canister 72 must be electrically isolated from the paint manifold 50 and the cleaning manifold 92 to prevent ground faults. The isolation lines 58 and 100 are therefore empty and clean during the painting operation to provide the electrical isolation.

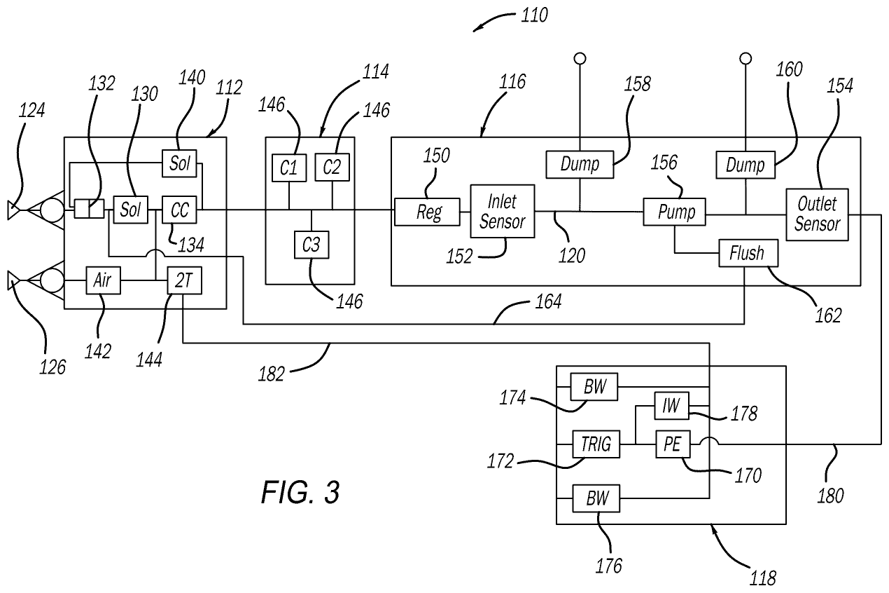

FIG. 3 is a schematic type diagram of another paint delivery system 110 that can be used with the painting robot 10. The system 110 includes a solvent/air manifold 112, a paint manifold 114 and a pump manifold 116 all tied to a common fluid line 120. Paint is provided from the pump manifold 116 to an applicator 118, representing, for example, the applicator 30, on line 180 to be dispensed onto the part. The solvent/air manifold 112 receives a cleaning solvent from a solvent source 124 and air from an air source 126. The solvent is provided to a solvent valve 130 through a flow controller 132 and then to a control valve 134. A solvent valve 140 allows the solvent to bypass the flow controller 132 and the control valve 134. Air is provided to an air valve 142, and solvent and/or air is provided to a solvent supply valve 144. The paint manifold 114 includes three paint valves 146 that selectively allow paint to be provided on the line 120, and can be the paint manifold discussed in detail below. It is noted that in other embodiments the system 110 can support multiple paint manifolds to provide more paint colors from more sources.

The pump manifold 116 includes a pressure regulator 150 that regulates the flow of fluid on the line 120, an inlet sensor 152 that measures fluid pressure on the line 120 at the inlet to the pump manifold 116 and an outlet sensor 154 that measures fluid pressure on the line 120 at the outlet to the pump manifold 116. The pump manifold 116 also includes a pump 156 that pumps the fluids through the system 110. A dump valve 158 at an inlet side of the pump 156 allows solvent or air to be dumped out of the system 110 and a dump valve 160 at an outlet side of the pump 156 allows solvent or air to be dumped out of the system 110. A flush valve 162 allows the pump manifold 116 to be flushed with solvent on line 164. The applicator 118 receives paint from the pump manifold 116 on the line 180 and dispenses it through a paint supply valve 170 and a trigger valve 172. Air and solvent are provided to applicator cleaning valves 174, 176 and 178 from the valve 144 on line 182.

As would be well understood by those skilled in the art, the various valves, pumps, flow controllers and other devices in the system 110 are suitably controlled to dispense paint from one of the color sources through one of the color valves 146, through the pump manifold 116 on the line 120, through the line 180 and through the valves 170 and 172 to be emitted from the applicator 118.

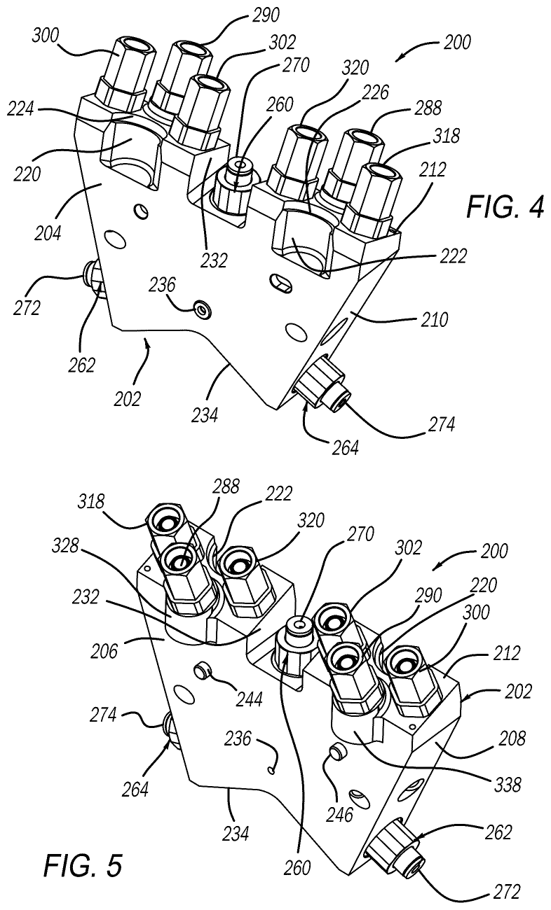

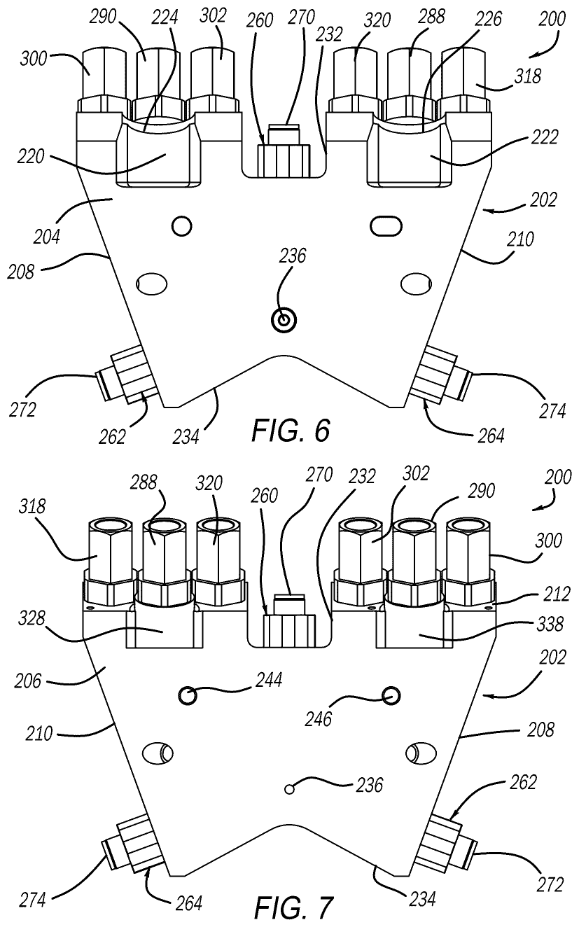

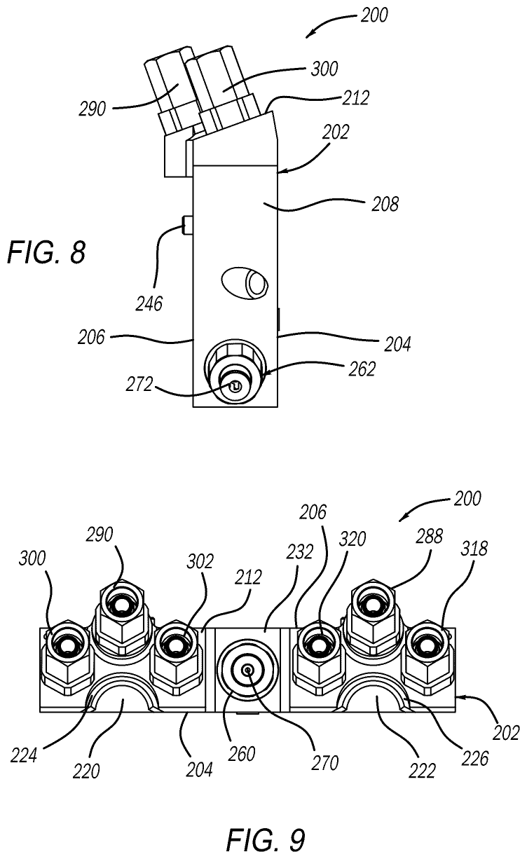

FIG. 4 is a front isometric view, FIG. 5 is a back isometric view, FIG. 6 is a front view, FIG. 7 is a back view, FIG. 8 is a side view and FIG. 9 is a top view of a paint manifold 200 that can be part of the paint manifold 50 in the paint delivery system 40 shown in FIG. 2 and the paint manifold 114 in the paint delivery system 110 shown in FIG. 3. The paint manifold 200 includes a specially shaped block 202 made of, for example, acetal copolymer, and having various faces and features, as shown. It is noted that a block shape of the manifold 200 is by way of a non-limiting example in that other shapes, such as semicircular, can also be employed. The block 202 includes a front side 204, a back side 206, a left side 208, a right side 210 and a top side 212. In one non-limiting embodiment, the block 202 is 18-58 mm deep between the front side 204 and the back side 206. The front side 204 includes recesses 220 and 222 that are open to the top side 212 and include a clearance step 224 and 226, respectively. The top side 212 includes a notch 232 and the block 202 includes a V-cut feature 234 at the bottom of the block 202. A center passage 236 passes through the block 202 from the front side 204 to the back side 206, and a pair of alignment bosses 244 and 246 extend from the back side 206 of the block 202.

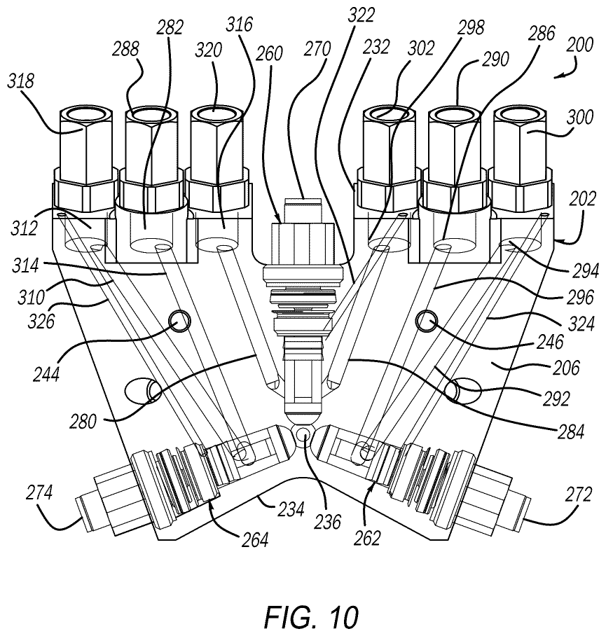

FIG. 10 is a front view of the paint manifold 200 where the block 202 is shown as being transparent to illustrate fluid passages therein. The paint manifold 200 includes a valve 260 extending into the block 202 through the notch 232 in the top side 212, a valve 262 extending into the block 202 through the left side 208 and a valve 264 extending into the block 202 through the right side 210, where ends of the valves 260, 262 and 264 are positioned proximate to the center passage 236 and where the valves 260, 262 and 264 are positioned on the same plane. The orientation angle of the valves 260, 262 and 264 relative to each other can be any angle suitable for the purposes discussed herein, for example, in a range of 85° to 125°. The valve 260 includes an air fitting 270 coupled to an end of the valve 260 opposite to the center passage 236, the valve 262 includes an air fitting 272 coupled to an end of the valve 262 opposite to the center passage 236, and the valve 264 includes an air fitting 274 coupled to an end of the valve 264 opposite to the center passage 236. This configuration of the valves 260, 262 and 264 minimizes the travel distance of the paint through the center passage 236 when the particular valve 260-264 is open, which reduces paint waste.

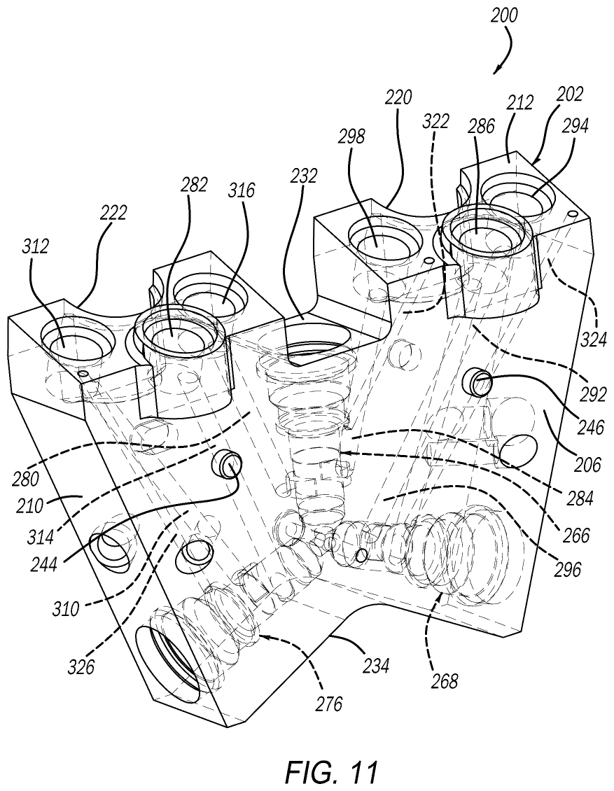

FIG. 11 is an isometric view of the block 202 with the valves 260, 262 and 264 removed. The block 202 includes a valve socket 266 having a configuration and features for accepting the valve 260 so that the block 202 acts as a valve body for the valve 260. Likewise, the block 202 includes a valve socket 268 having a configuration and features for accepting the valve 262 so that the block 202 acts as a valve body for the valve 262. Likewise, the block 202 includes a valve socket 276 having a configuration and features for accepting the valve 264 so that the block 202 acts as a valve body for the valve 264.

Each valve 260, 262 and 264 allows the flow of paint from a different paint source to the center passage 236. A supply passage 280 is coupled to the valve 260 and a supply fitting socket 316 in the block 202 through the top side 212 and a return passage 284 is coupled to the valve 260 and a return fitting socket 298 in the block 202 through the top side 212, where a paint fitting 320 is inserted into the socket 316 and a paint fitting 302 is inserted into the socket 298. When the valve 260 is closed, paint from a paint source can circulate through the supply passage 280, through a chamber in the valve 260, through the return passage 284 and back to the paint source. When the valve 260 is open, paint from the supply passage 280 is directed to the center passage 236.

Likewise, a supply passage 292 is coupled to the valve 262 and a supply fitting socket 294 in the block 202 through the top side 212 and a return passage 296 is coupled to the valve 262 and a return fitting socket 286 in the block 202 through the top side 212, where a paint fitting 300 is inserted into the socket 294 and a paint fitting 290 is inserted into the socket 286. When the valve 262 is closed, paint from a paint source can circulate through the supply passage 292, through a chamber in the valve 262, through the return passage 296 and back to the paint source. When the valve 262 is open, paint from the supply passage 292 is directed to the center passage 236.

Likewise, a supply passage 310 is coupled to the valve 264 and a supply fitting socket 312 in the block 202 through the top side 212 and a return passage 314 is coupled to the valve 264 and a return fitting socket 282 in the block 202 through the top side 212, where a paint fitting 318 is inserted into the socket 312 and a paint fitting 288 is inserted into the socket 282. When the valve 264 is closed, paint from a paint source can circulate through the supply passage 310, through a chamber in the valve 264, through the return passage 314 and back to the paint source. When the valve 264 is open, paint from the supply passage 310 is directed to the center passage 236. It is noted that the layout of the sockets 282, 312 and 316 requires a boss 328 and the layout of the sockets 286, 294 and 298 requires a boss 338 to allow multiple manifolds to be stacked back-to-back because the recesses 220 and 222 operate as a clearance cutout for the bosses of adjacent manifolds.

A weep passage 322 allows a visual indication of whether seals at the fluid side of the valve 260 are leaking, a weep passage 324 allows a visual indication of whether seals at the fluid side of the valve 262 are leaking and a weep passage 326 allows a visual indication of whether seals at the fluid side of the valve 264 are leaking.

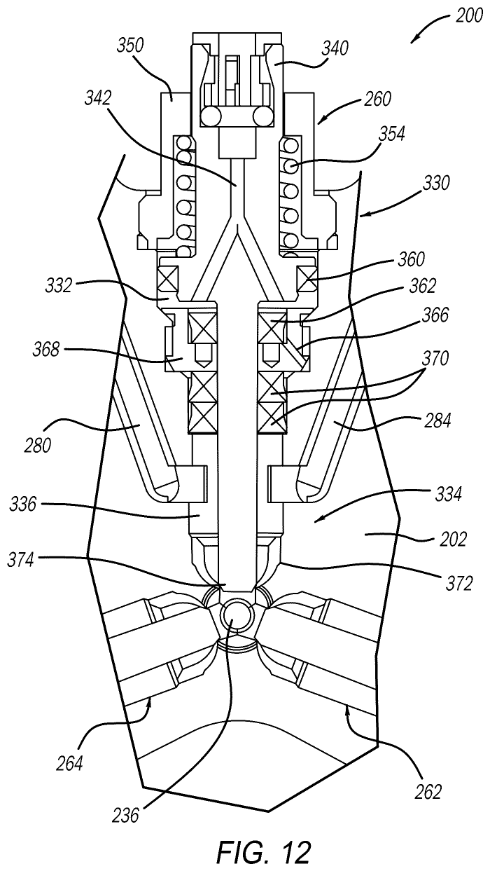

FIG. 12 is a broken away front view of the paint manifold 200 illustrating a cross-sectional type view of the valve 260 positioned within the socket 266 with the understanding that the valves 262 and 264 are identical to the valve 260. The valve 260 includes an airside 330 having an air chamber 332 that receives pilot air and a fluid side 334 having a paint chamber 336 that receives the paint from the supply passage 280. The valve 260 further includes a valve stem 340 that extends the length of the valve 260 and is coupled to a valve tip 374, which is seated in a valve seat 372 having a hemispherical surface. A pilot passage 342 extends through the valve stem 340 to provide pilot air to the air chamber 332. A valve cap 350 is provided over the valve stem 340 and a valve spring 354 is provided between the valve cap 350 and the valve stem 340. A piston seal 360 and a pilot side seal 362 seal the air chamber 332, and fluid side rod seals 370 seal the paint chamber 336. A seal holder 368 holds the pilot side seal 362 in place, which prevents pilot air from entering the paint chamber 336. A weep passage 366 is in fluid communication with the weep passage 322.

When pilot air is provided to the pilot passage 342 the air chamber 332 is pressurized, which causes the valve stem 340 to move upward against the bias of the spring 354 and separate the valve tip 374 from the valve seat 372 allowing paint to be dispensed from the paint chamber 336 into the center passage 236. When the pilot air is removed, the spring 354 pushes the valve stem 340 downward, which reseats the valve tip 374 in the valve seat 372 and closes the valve 260.

In the known valve designs, fluid side rod seals seal the valve stem on the seal inner diameter and the valve body on the seal outer diameter. However, for the manifold 200, the fluid side rod seals 370 seal directly on the block 202 on the outer diameter of the seals 370. Since the block 202 acts as the valve body for the valves 260, 262 and 264, the paint manifold 200 has a more compact design and which reduces cost by eliminating external O-ring seals required for the known valve design. Further, removing the valve body allows the supply passages 280, 292 and 310 and the return passages 284, 296 and 314 to be angled relative to the respective valve 260, 262 and 264, which also helps with the compact design of the paint manifold 200. The seal holder 368 has a retention feature for the pilot seal 362 and allows the use of a common dynamic seal. The seal holder 368 also has features that create a seal with the block 202 without the need for an elastomeric seal. The valve seat 372 minimizes the size of the seat 372 around the valve tip 374 to allow closer spacing between the valves 260, 262 and 264, which is achieved by moving the retention feature of the seat 372 away from the valve tip 374. This closer spacing is enabled by the hemispherical outer shape of the seat 372. In another embodiment that can provide such closer spacing, the seat 372 includes a generally conical outer shape. In yet another embodiment that enables such closer spacing, a single piece construction can be provided where the seats 372 for the valves 260, 262 and 264 are combined into a single component. The design of the valve stem 340 allows the air fitting 270 to be connected directly to the stem 340.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A fluid manifold comprising:
a body including a fluid passage extending therethrough;
a first valve extending into the body and having a valve tip positioned proximate the fluid passage;
a second valve extending into the body and having a valve tip positioned proximate the fluid passage; and
a third valve extending into the body and having a valve tip positioned proximate the fluid passage, wherein each valve includes a valve rod seal having sealing surfaces that seal against the body.

2. The manifold according to claim 1 wherein the body is a block including a front side, a back side, a left side, a right side and a top side, said fluid passage extending through the block between the front side and the back side.

3. The manifold according to claim 2 wherein the first valve extends into the block through the top side, the second valve extends into the block through the right side, and the third valve extends into the block through the left side.

4. The manifold according to claim 2 wherein the block has a thickness between the front side and the back side in the range of 18-58 mm.

5. The manifold according to claim 1 wherein the first, second and third valves each have a length that is positioned along a common plane.

6. The manifold according to claim 5 wherein the first, second and third valves are oriented relative to each other at an angle between 85° and 125°.

7. The manifold according to claim 1 further comprising a first fluid supply passage extending through the body and being coupled to the first valve, a first fluid return passage extending through the body and being coupled to the first valve, a second fluid supply passage extending through the body and being coupled to the second valve, a second fluid return passage extending through the body and being coupled to the second valve, a third fluid supply passage extending through the body and being coupled to the third valve, and a third fluid return passage extending through the body and being coupled to the third valve.

8. The manifold according to claim 1 wherein each valve includes an air chamber and a fluid chamber, and wherein the air chamber is pressurized with air to actuate the valve.

9. The manifold according to claim 8 wherein each valve includes a pilot seal that seals a pilot air chamber and a seal holder that holds the pilot seal in place to prevent air from entering the fluid chamber.

10. The manifold according to claim 1 wherein each valve includes a valve seat having a hemispherical surface.

11. The manifold according to claim 1 wherein each valve includes a weep passage in fluid communication with a weep fluid passage extending through the body.

12. The manifold according to claim 1 wherein the manifold is part of a paint delivery system and the fluid is paint.

13. The manifold according to claim 12 wherein the paint delivery system is part of a painting robot.

14. A paint manifold that is part of a paint delivery system on a painting robot, said manifold comprising:
a body including a front side, a back side, a left side, a right side and a top side and a fluid passage extending through the body between the front side and the back side;
a first valve extending into the body and having a valve tip positioned proximate the fluid passage, wherein the first valve extends into the body through the top side;
a second valve extending into the body and having a valve tip positioned proximate the fluid passage, wherein the second valve extends into the body through the right side; and
a third valve extending into the body and having a valve tip positioned proximate the fluid passage, wherein the third valve extends into the body through the left side, and wherein the first, second and third valves each have a length that is positioned along a common plane, and wherein each valve includes a valve rod seal having sealing surfaces that seal against the body and a valve seat having a hemispherical surface.

15. The manifold according to claim 14 wherein the body has a thickness between the front side and the back side in the range of 18-58 mm.

16. The manifold according to claim 14 wherein the first, second and third valves are oriented relative to each other at an angle between 85° and 125°.

17. The manifold according to claim 14 further comprising a first fluid supply passage extending through the body and being coupled to the first valve, a first fluid return passage extending through the body and being coupled to the first valve, a second fluid supply passage extending through the body and being coupled to the second valve, a second fluid return passage extending through the body and being coupled to the second valve, a third fluid supply passage extending through the body and being coupled to the third valve, and a third fluid return passage extending through the body and being coupled to the third valve.

18. A paint manifold comprising:
a body including a fluid passage extending therethrough;
a first valve extending into the body and having a valve tip positioned proximate the fluid passage;
a second valve extending into the body and having a valve tip positioned proximate the fluid passage;
a third valve extending into the body and having a valve tip positioned proximate the fluid passage, wherein each valve includes a valve rod seal having sealing surfaces that seal against the body and a valve seat having a hemispherical surface;
a first fluid supply passage extending through the body and being coupled to the first valve;
a first fluid return passage extending through the body and being coupled to the first valve;
a second fluid supply passage extending through the body and being coupled to the second valve;
a second fluid return passage extending through the body and being coupled to the second valve;
a third fluid supply passage extending through the body and being coupled to the third valve; and
a third fluid return passage extending through the body and being coupled to the third valve.

19. The manifold according to claim 18 wherein the body is a block including a front side, a back side, a left side, a right side and a top side, said fluid passage extending through the block between the front side and the back side, and wherein the first valve extends into the block through the top side, the second valve extends into the block through the right side, and the third valve extends into the block through the left side.

20. The manifold according to claim 18 wherein each valve includes a weep passage in fluid communication with a weep fluid passage extending through the body.
